(19) United States
(12) Patent Application Publication
(10) Pub. No.: US 2011/0079299 A1
(43) Pub. Date: Apr. 7, 2011

(54) CHECK VALVE

(75) Inventors: Katsushi YUGUCHI, Shizuoka-shi (JP); Kazushige TAJIMA, Shizuoka-shi (JP)

(73) Assignee: STAR MICRONICS CO., LTD., Shizuoka-shi (JP)

(21) Appl. No.: 12/573,365

(22) Filed: Oct. 5, 2009

(51) Int. Cl. F16K 15/00

(52) U.S. Cl. 137/511

(57) ABSTRACT

A check valve includes: a base member provided with an inlet channel along which fluid flows in one direction; a valve unit disposed on a valve mounting surface and including a film valve body and a frame body; and a valve seating surface defined on the valve mounting surface at the periphery of the opening of the inlet channel, wherein one or more communicating grooves are formed on the valve mounting surface across the frame body so as to extend from the valve seating surface to the outside of the frame body, wherein the inlet channel is blocked by the film valve body when the film valve body is in contact with the valve seating surface, and wherein the inlet channel and the outside of the frame body are communicated via the communicating grooves when the film valve body is separated from the valve seating surface.

### CROSS-REFERENCE TO THE RELATED APPLICATION(S)

The present disclosure relates to the subject matters contained in Japanese Patent Application No. 2007-338717 filed on Dec. 28, 2007, which are incorporated herein by reference in its entirety.

### FIELD

The present invention relates to a check valve provided in the fluid channel for gas or liquid to allow flow in one direction while preventing reverse flow. The check valve according to the present invention is preferably built into a pump such as a micro-pump for pumping fluid by flexing and vibrating a thin diaphragm.

### BACKGROUND

A micro-pump for constantly pumping a relatively small amount of fluid with high accuracy is conventionally provided. Diaphragm pumps are well known as this kind of a pump (for example, see JP-A-2002-106468). In a diaphragm pump, part of a wall of a pump chamber is configured by a flexible thin vibrator called diaphragm. The diaphragm is flexed and vibrated by an actuating device such as a piezoelectric element, thereby ejecting entered fluid outside the pump chamber.

Such kind of a diaphragm pump is provided with a housing, which forms the pump chamber together with the diaphragm. The housing is provided with a suction channel for introducing fluid into the pump chamber and a discharge channel for ejecting fluid outside the pump chamber. Both of the channels are provided with check valves respectively. In the check valve, a film valve body having elasticity is generally used as shown in JP-A-2002-106468.

The film valve body is deformed to open the channel by the flow pressure in a desired direction and deformed back to close the channel by the reverse flow pressure in the opposite direction. Various configurations are provided. FIGS. 7A-7C respectively show a film valve body adapted to open and close an opening 101 of a channel formed in a housing 100. FIG. 7A shows a cantilever configuration in which a strip film 110 is at one end thereof fixed to the housing 100. The strip film 110 is swingeable at the other end to open the opening 101 when fluid flows from below as shown in the figure. When fluid flows from above, downward flow pressure forces the strip film 110 in contact with the periphery of the opening 101, thereby closing the opening 101 to stop the flow.

FIG. 7B shows another configuration in which the film 110 covering the opening 101 is at the both ends thereof fixed to the housing 100. The film 110 is flexed to open the opening 101 by the flow pressure from below. FIG. 7C shows another configuration in which the film 110 is at the four corners thereof fixed to the housing 100. The film 110 is flexed to open the opening 101 by the flow pressure from below.

A thin and light film valve body is advantageous in that it is surely and immediately opened or closed in response to fluid flow. The film valve body, however, has a limited durability at the edge thereof as it is exposed to fluid flow while the film valve body is repeatedly flexed by flow pressure. As shown in FIGS. 7B and 7C, the film valve body is fixed at the opposite ends or at the four corners, the remaining free edge is subject to tension stress and easily be torn. Further, the film valve body generally has a difficulty in assembling efficiency since it is delicate and easy to get wrinkled or bent.

### SUMMARY

According to an aspect of the invention, there is provided a check valve including: a base member provided with an inlet channel along which fluid flows in one direction; a valve unit disposed on a valve mounting surface defined on one of the faces of the base member and operative to open and close the inlet channel in response to the pressure of fluid; and a valve seating surface defined on the valve mounting surface at the periphery of the opening of the inlet channel, wherein the valve unit includes: a film valve body configured to be in contact with the valve seating surface or to be separated from the valve seating surface; and a frame body on which the film valve body is tightly stretched, wherein one or more communicating grooves are formed on the valve mounting surface across the frame body so as to extend from the valve seating surface to the outside of the frame body, wherein the inlet channel is blocked by the film valve body when the film valve body is in contact with the valve seating surface, and wherein the inlet channel and the outside of the frame body are communicated via the communicating grooves when the film valve body is separated from the valve seating surface.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a cross sectional view of a diaphragm pump including a check valve in accordance with an embodiment of the present invention.

FIGS. 2A and 2B are cross-sectional views of a check valve in accordance with an embodiment of the present invention, wherein FIG. 2A shows the closed state and FIG. 2B shows the opened state.

FIG. 3 is a view seen from a direction shown by an arrow III in FIG. 2A.

FIG. 4A is an exploded perspective view of a valve unit constituting a check valve and FIG. 4B is a perspective view thereof after assembly.

FIGS. 5A and 5B are perspective views of a valve unit in operation, wherein FIG. 5A shows the closed state and FIG. 5B is the opened state.

FIG. 6A and FIG. 6B are plan views of a guide member for positioning the valve unit.

FIGS. 7A-7C are perspective views of a conventional check valve.

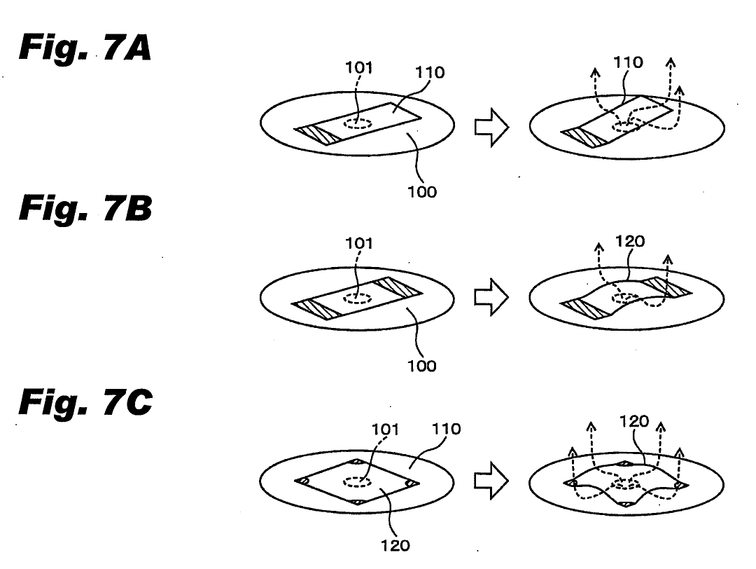

### DETAILED DESCRIPTION OF THE EMBODIMENTS

A check valve according to an embodiment of the present invention applied in a diaphragm pump will be described with reference to the accompanying drawings.

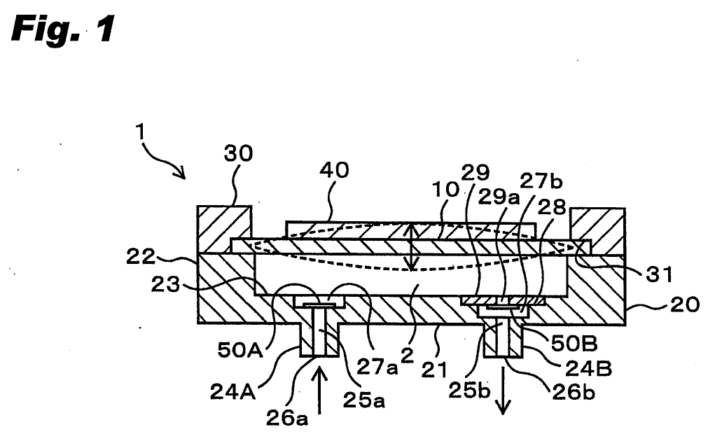

FIG. 1 is a cross-sectional view of a diaphragm pump 1 for air pumping according to the embodiment of the present invention. The pump 1 is provided with a disc-shaped diaphragm 10, a disc-shaped housing 20 and an annular cover 30 flexibly supporting therebetween the diaphragm10 at the circumference thereof, and a piezoelectric element 40 for activating the diaphragm 10 to be flexed and vibrated.

The housing 20 has a circular bottom plate 21. An annular peripheral wall 22 is formed at the upper periphery of the bottom plate 21 in the figure. An inner recess of the peripheral wall 22 is a pump chamber recess 23. The pump chamber recess 23 is enclosed by the diaphragm 10, constituting a pump chamber 2.

The bottom plate 21 has a pair of connecting pipes 24A and 24B projecting downward. The connecting pipe 24A (the left side in FIG. 1) is on the suction side and the connecting pipe 24B (the right side in FIG. 1) is on the ejection side. A suction channel 25a is formed in the suction side connecting pipe 24A and an ejection channel 25b is formed in the ejection side connecting pipe 24B. The leading opening end of the suction channel 25a constitutes an inlet 26a and the leading opening end of the ejection channel 25b constitutes an outlet 26b. A tube (not shown) is connected to the suction side connecting pipe 24A to introduce air therein. Another tube (not shown) is connected to the ejection side connecting pipe 24B to introduce air thereout.

A circular suction side valve housing recess 27a is formed on the upper surface of the bottom plate 21 at the position corresponding to the suction side connecting pipe 24A. The suction channel 25a is open to the suction side valve housing recess 27a. A suction side check valve 50A in the shape of a disc is fixed to the bottom surface of the suction side valve housing recess 27a so as to close the opening of the suction channel 25a.

An ejection side valve housing recess 27b is formed on the upper surface of the bottom plate 21 at the position corresponding to the ejection side connecting pipe 24B. The ejection side valve housing recess 27b is of the same size and shape as the suction side valve housing recess 27a, but positioned deeper (lower in the figure). A circular differential recess 28 is formed on the upper surface of the bottom plate 21 at the periphery of the ejection side valve housing recess 27b. A disc-shaped lid plate 29 is engaged with the differential recess 28 and fixed thereto. An ejection hole 29a communicating between the pump chamber recess 23 and the ejecting side valve housing recess 27b is formed at the center of the lid plate 29. The upper surface of the lid plate 29 is coplanar with the upper surface of the bottom plate 21. An ejection side check valve 50B in the shape of a disc is housed in the ejection side valve housing recess 27b and fixed to the lower surface of the lid plate 29 so as to close the ejection hole 29a.

The suction side check valve 50A allows air to enter into the pump chamber 2 from the suction channel 25a and prevents the reverse flow. The ejection side check valve 50B allows air to enter into the ejection channel 25b from the pump chamber 2 and prevents the reverse flow. The suction side check valve 50A and the ejection side check valve 50B has the same configuration. The configuration and operation of the check valves 50A and 50B of the present invention are described later.

The cover 30 is equivalent to the housing 20 in external diameter and equivalent to or slightly larger than the pump chamber recess 23 in internal diameter. The lower surface of the cover 30 is joined to the upper surface of the peripheral wall 22. An annular groove 31 opening inward is formed on the lower surface of the cover 30 at the inner circumferential side. The annular groove 31 has the depth almost equivalent to the thickness of the diaphragm 10. The diaphragm 10 is, at the edge thereof, fitted in the groove 31. The cover 30 is placed concentrically on the upper surface of the periphery wall 22 of the housing 20 and joined to the housing 20 with the diaphragm 10 engaged therebetween. The joint between the cover 30 and the housing 20 is available by adhesive bonding or a bolt screwed between the cover 30 and the housing 20.

The diaphragm 10 is made of an elastic metal thin plate or other material and shaped like a disc. The piezoelectric element 40 in the shape of a disc of smaller diameter than the internal diameter of the cover 30 is concentrically disposed on one of the sides of the diaphragm 10 (the upper side in FIG. 1) and attached thereto by adhesive or other fastening means. The diaphragm 10 having the piezoelectric element 40 mounted thereon is fitted in the groove 31 of the cover 30 and supported between the cover 30 and the housing 20 as described above. The diaphragm 10 covering the pump chamber recess 23 is airtightly fixed to the housing 20. The pump chamber recess 23 constitutes the pump chamber 2 enclosed by the housing 20 and the diaphragm 10.

Described above is the configuration of the diaphragm pump 1. The operation thereof is described below.

A driving signal such as an alternating signal is applied to the piezoelectric element 40. In response to the applied signal, the piezoelectric element 40 contracts and vibrates in diameter direction, thereby the diaphragm 10 is flexed and vibrated in the upper and lower direction together with the piezoelectric element 40.

When the diaphragm 10 is flexed upward (in the direction away from the housing 20), the volume of the pump chamber 2 is increased and the pressure therein becomes negative. In response to the negative pressure, the suction side check valve 50A is opened to force air to enter into the suction channel 25a via the inlet 26a. Air passing through the opened check valve 50A is forced to enter into the pump chamber 2 via the suction side valve housing recess 27a. The ejection side check valve 50B remained closed in response to the negative pressure, therefore air is disallowed to enter from the outlet 26b.

When the diaphragm 10 is flexed downward (toward the housing 20), the volume of the pump chamber 2 is reduced and the pressure therein becomes positive. In response to the positive pressure, the ejection side check valve 50B is opened. Air passing through the opened ejection side check valve 50B is ejected from the outlet 26b via the ejection side valve housing recess 27b and the ejection channel 25b. The suction side check valve 50A remained closed in response to the positive pressure, therefore air in the pump chamber 2 is disallowed to be ejected from the inlet 26a.

Repeated suction and ejection operations as above described cause the pumping operations to occur continually. Air drawn into the pump chamber 2 via the inlet 26b is pumped out via the outlet 23b.

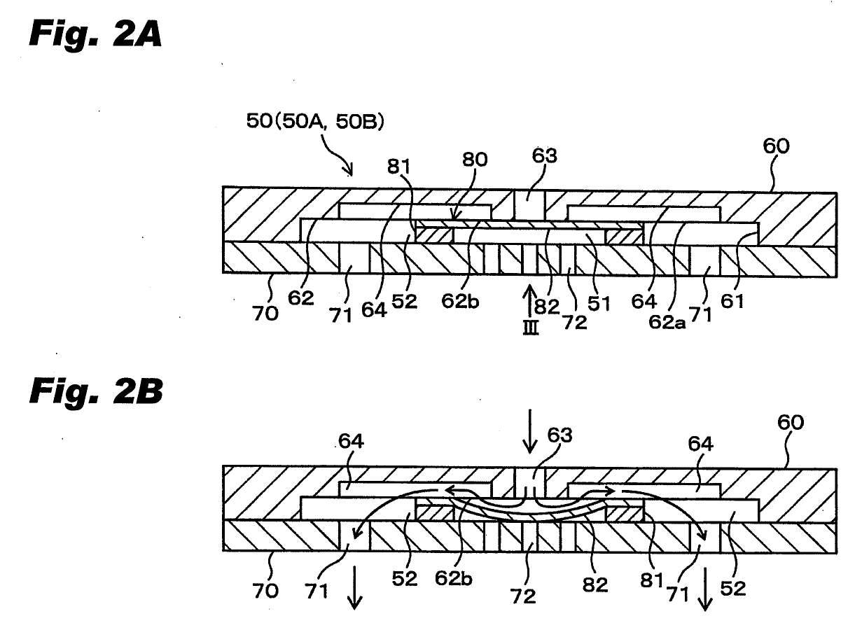

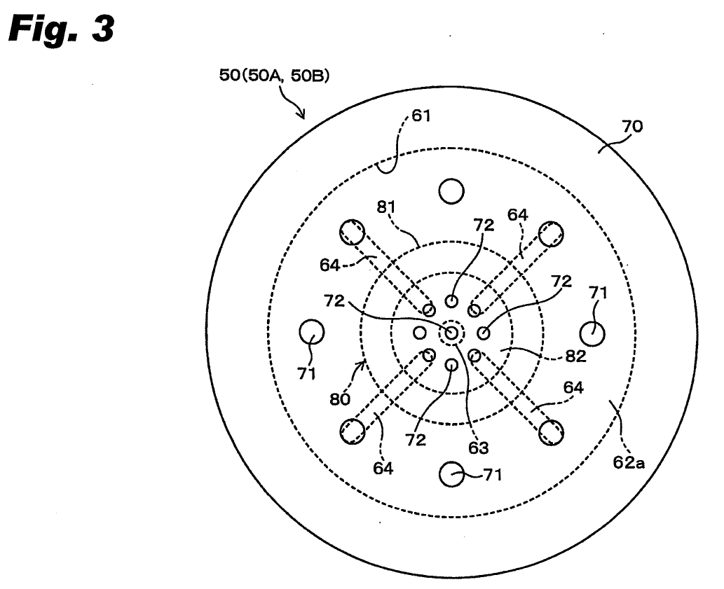

The suction side check valve 50A and the ejection side check valve 50B are described below referring to FIGS. 2 to 5. They are of the same configuration as described above, therefore they are collectively called a check valve 50 if distinguishing is not necessary. FIG. 2 is a cross-sectional view of the check valve 50. FIG. 3 is a view seen from a direction shown by an arrow III in FIG. 2A. The check valve 50 is provided with an upstream side valve plate 60 and a downstream side valve plate 70 as shown in FIG. 2. The valve plates 60 and 70 are in the same external shape of a disc and concentrically joined to each other. An annular thick portion 61 is formed at the periphery of the lower surface of the upstream side valve plate 60 (the facing surface to the downstream side valve plate 70). Thereby, a circular shallow recess 62 is formed inside the annular thick portion 61. An inlet channel 63 is penetrated at the center of the upstream side valve plate 60.

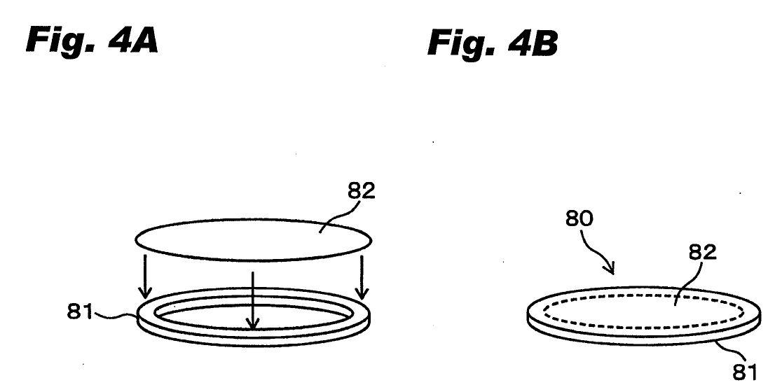

A disc-shaped valve unit 80 is concentrically disposed and fixed at the center of the bottom surface 62a of the recess 62. The valve unit 80 is, as shown in FIG. 4, configured by an annular frame body 81 and a film valve body 82 stretched tight on one of the sides of the frame body 81. The frame body 81 is made of relatively rigid material and preferably a stainless ring about 10 μm in thickness having the cross sectional shape of a rectangle, for example. The valve body 82 is preferably made of a PET film about 2 μm in thickness, which is cut into a circular piece, for example. The valve body 82 is almost equivalent to the frame body 81 in external diameter. The entire edge of the valve body 82 is airtightly joined to one of the sides of the frame body 81 by adhesive or other means. With the valve body 82 side of the valve unit 80 facing the bottom surface 62a of the recess 62, the valve body 82 is attached to the bottom surface 62a by adhesive or other means at the edge portion joined to the frame body 81. The valve unit 80 is thereby fixed to the bottom surface 62a of the recess 62 of the upstream side valve plate 60.

The thickness of the valve unit 80 (the total thickness of the frame body 81 and the valve body 82) is equivalent to the depth of the recess 62. The valve unit 80 sandwiched between the upper and lower valve plates 60 and 70 is built within the check valve 50. The downstream side valve plate 60 is joined to the upstream side valve plate 70, thereby the internal space of the frame body 81 is separated into a compartment constituting an inside space 51 and the external space of the frame body 81 within the recess 62 is separated into another compartment constituting an outside space 52. The valve unit 80 may not be bonded to the bottom surface 62a of the recess 62 and instead it may be only pressed and thereby supported between the upper and lower valve plates 70 and 80.

The valve unit 80 is concentrically disposed at the center of the bottom surface 62a of the recess 62. The valve body 82 of the valve unit 80 is normally in contact with the bottom surface 62a as shown in FIG. 2A. The inlet channel 63 of the upstream side valve plate 60 is thereby blocked by the valve body 82. The area of the bottom surface 62a with which the valve body 82 is in contact constitutes a valve seating surface 62b.

When air enters through the inlet channel 63, the flow pressure is applied to the valve body 82 so that it is flexed and swollen toward the downstream side valve plate 70 as shown in FIG. 2B. On the bottom surface 62a of the recess 62, a plurality of linear communicating grooves 64 extending from the valve seating surface 62b to the outside space 52 are formed across the frame body 81. In the embodiment, four communicating grooves 64 are radially formed with a center on the inlet channel 63.

On the downstream side valve plate 70, formed are a plurality of discharge holes 71 communicating the outside space 52 with the outside and a plurality of back pressure holes 72 communicating the inside space 51 with the outside. As shown in FIG. 3, each of the discharge holes 71 and the back pressure holes 72 is a relatively small circular hole. The discharge holes 71 are circumferentially disposed at regular intervals on the downstream side valve plate 70. The back pressure holes 72 are circumferentially disposed at regular intervals on the downstream side valve plate 70 with one of the holes placed at the center thereof.

Described above is the configuration of the check valve 50. The check valve 50 is disposed so as to block the passage of fluid with the upstream side valve plate 60 at the upstream side of fluid and the downstream side valve plate 70 at the downstream side thereof. In the diaphragm pump1 in FIG. 1, the check valve 50 is housed in the suction side valve housing recess 27a as the suction side check valve 50A and in the ejection side valve housing recess 27b as the ejection side check valve 50B.

For the suction side check valve 50A, the upstream side valve plate 60 is fixed to the bottom surface of the suction side valve housing recess 27a with the inlet channel 63 communicating with the suction channel 25a. For the ejection side check valve 50B, the upstream side valve plate 60 is fixed to the lower surface of the lid plate with the inlet channel 63 communicating with the ejection hole 29a. When the diaphragm 10 is flexed to increase the volume of the pump chamber 2, the suction side check valve 50A is opened to force air to enter into the pump chamber 2 while the ejection side check valve 50B is closed. When the diaphragm 10 is flexed to reduce the volume of the pump chamber 2, the ejection side check valve 50B is opened to force air to be ejected from the pump chamber 2 while the suction side check valve 50A is closed. The opening and closing operations of the check valve 50 is described below.

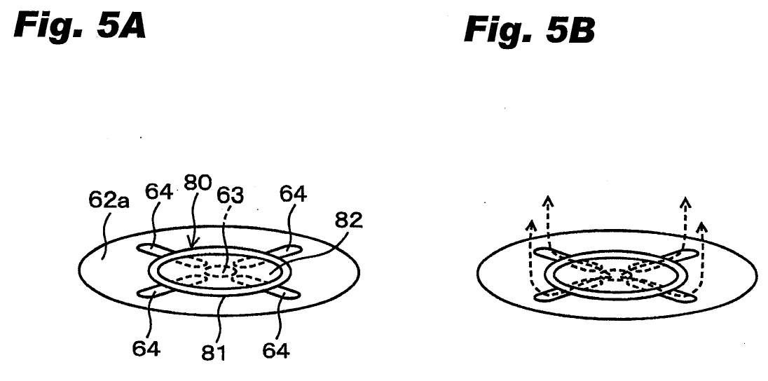

The check valve 50 is normally closed with the valve body 82 in contact with the valve seating surface 62b as shown in FIG. 2A and FIG. 5A. The check valve 50 is opened when air enters from the inlet channel 63 toward the valve body 82. For the suction side check valve 50A, air enters from the inlet channel 63 toward the valve body 82 when air enters from the inlet 26a toward the pump chamber 2. For the ejection side check valve 50B, air enters from the inlet channel 63 toward the valve body 82 when air in the pump chamber 2 flows out from the ejection hole 29a of the lid plate 29 toward the ejection channel 25b.

When air enters into the inlet channel 63, the valve body 82 is flexed and swollen toward the downstream side valve plate 70. The valve body 82 is thereby separated from the valve seating surface 62b. The check valve 50 is thereby opened. Air entered into the space between the valve seating surface 62b and the valve body 82 flows along the communicating grooves 64 toward outside, passes through the frame body 81 and reaches the outside space 52. FIG. 5B shows air flow by the broken arrow line. Air in the outside space 52 is then discharged from the discharge holes 71 toward the downstream space. The downstream space on the suction side corresponds to the suction side valve housing recess 27a communicating with the pump chamber 2. The downstream space on the ejection side corresponds to the ejection side valve housing recess 27b communicating with the ejection channel 25b.

When air flow described above is reversed, the check valve 50 is closed to block the reverse flow. For the suction side check valve 50A, the reverse flow occurs when air flows from the pump chamber 2 toward the suction side check valve 50A. For the ejection side check valve 50B, the reverse flow occurs when air enters from the outlet 26b toward the pump chamber 2.

When the reverse flow occurs, the pressure is applied to the downstream side valve plate 70 to force air to enter into the inside space 51 through the back pressure holes 72. The valve body 82 is pressed by entered air, thereby brought into contact with the valve seating surface 62b. The inlet channel 63 is thereby blocked and closed. Air may also enter from the discharge holes 71 and flow into the communicating grooves 64 via the outside space 52, but air in the communicating grooves 64 is blocked since the valve body 82 is in contact with the valve seating surface 62b.

According to the check valve 50 of the present embodiment, the valve body 82 flexing to open and close the inlet channel 63 is stretched tight on the frame body with the edge of the valve body 82 fixed thereto. Therefore, the valve body 82 is reinforced by the frame body 81. When the valve body 82 is flexed and deformed, the edge thereof is not subject to tension stress due to air flow. The valve body 82 is equally flexed over the entire surface thereof, and therefore damage to the edge such as a tear is prevented. The valve body 82 even using a film maintains high durability.

Further, since the edge of the valve body 82 is firmly held, the opening and closing operations are smooth and sure. The valve body 82 of the embodiment is preferably used especially when the valve body 82 needs to be thin and light or needs high durability to follow the vibration of the diaphragm 10 at high frequency (for example, when the diaphragm resonates around 20 KHz). Further, since the film valve body 82 is stretched tight on the frame body 81 and configured into the valve unit 80, the valve body 82 is resistant to bends or wrinkles. This improves work efficiency in assembly.

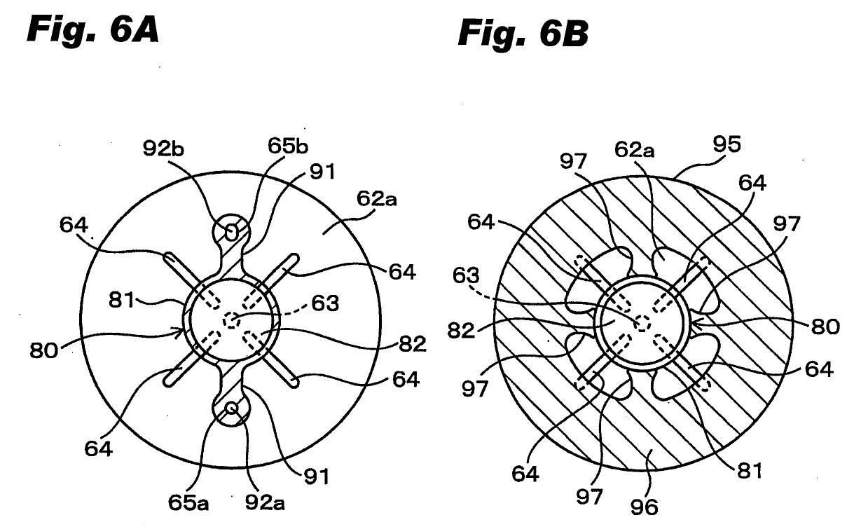

In the valve unit 50 of the embodiment, a guide member may be preferably provided to appropriately position the valve unit 80 concentrically on the bottom surface 62a of the recess 62 of the upstream side valve plate 60. FIG. 6A shows a pair of guide pieces 91 integrally formed with the frame body 81 of the valve unit 80. The guide piece 91 is a long plate of the same thickness as the frame body 81, having portions extending outward in diameter direction from the 180 degrees opposite positions on the circumferential surface of the frame body 81. The leading ends of the guide piece 91 are circular-shaped, having pinholes 92a and 92b at the center thereof respectively. The pin hole 92a is circular while the pin hole 92b is long hole extending in diameter direction. In the embodiment, the pin holes 92a and 92b of the guide piece 91 are engaged with pins 65a and 65b projected on the bottom surface 62a respectively, thereby the valve unit 80 is positioned on the bottom surface 62a.

FIG. 6B shows a guide member 95 made of an annular plate. The guide member 95 has an annular portion 96 having the diameter engageable within the recess 62. Inside the annular portion 96, a plurality of guide pieces 97 (four pieces in this example) extending inward in diameter direction are integrally formed. The leading end of each of the guide pieces 97 is bent into the shape of a concave so that it is engaged with the circumferential surface of the frame body 81. The guide member 95 is engaged within the recess 62 and fixed to the bottom surface 62a by adhesive or other means. The valve unit 80 is positioned on the bottom surface 62a with the frame body 81 engaged within the guide pieces 97.

In the check valve 50 of the embodiment, the frame body 81 of the valve unit 80 is in the shape of a circular ring, but it may be in the shape of a rectangular ring.

The plurality of communicating grooves 64 are radially arranged, but they may be parallely arranged.

In the check valve 50 of the embodiment, the downstream side valve plate 70 may be eliminated from the configuration. The upstream side valve plate 60 may be replaced by the housing 20 or the lid plate 29. In the suction side check valve 50A, the bottom surface of the suction side valve housing recess 27a corresponds to the bottom surface 62a of the upstream side valve plate 60. Then the valve unit 80 may be directly fixed to the bottom surface of the suction side valve housing recess 27a to block the opening of the suction channel 25a.

In the ejection side check valve 50B, the lower surface of the lid plate 29 corresponds to the bottom surface 62a of the upstream side valve plate 60. The valve unit 80 may be directly fixed to the lower surface of the lid plate 29 to cover the ejection hole 29a. The periphery of the opening of the ejection hole 29a blocked by the valve body 82 constitutes the valve seating surface 62b. In any case, on the surface where the valve unit 80 is fixed, communicating grooves corresponding to the communicating grooves 64 are formed extending from the valve seating surface toward the external side of the frame body 81.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from the configurations described as the embodiment.

What is claimed is:

1. A check valve comprising:
a base member provided with an inlet channel along which fluid flows in one direction;
a valve unit disposed on a valve mounting surface defined on one of the faces of the base member and operative to open and close the inlet channel in response to the pressure of fluid; and
a valve seating surface defined on the valve mounting surface at the periphery of the opening of the inlet channel,
wherein the valve unit comprises:
a film valve body configured to be in contact with the valve seating surface or to be separated from the valve seating surface; and
a frame body on which the film valve body is tightly stretched,
wherein one or more communicating grooves are formed on the valve mounting surface across the frame body so as to extend from the valve seating surface to the outside of the frame body,
wherein the inlet channel is blocked by the film valve body when the film valve body is in contact with the valve seating surface, and
wherein the inlet channel and the outside of the frame body are communicated via the communicating grooves when the film valve body is separated from the valve seating surface.

2. The check valve according to claim 1, wherein the valve mounting surface is formed with a plurality of the communicating grooves being radially arranged with a center on the inlet channel.

3. The check valve according to claim 1 further comprising a guide member for positioning the frame body on the valve mounting surface.

4. The check valve according to claim 2 further comprising a guide member for positioning the frame body on the valve mounting surface.
